(19) United States
(12) Patent Application Publication
(10) Pub. No.: US 2012/0110581 A1
(43) Pub. Date: May 3, 2012

(54) TASK CANCELLATION GRACE PERIODS

(75) Inventors: Colin Watson, Kirkland, WA (US); Sayantan Chakravorty, Redmond, WA (US); Jun Su, Shanghai (CN)

(73) Assignee: Microsoft Corporation, Redmond, WA (US)

(21) Appl. No.: 13/101,156

(22) Filed: May 5, 2011

(30) Foreign Application Priority Data
Oct. 28, 2010 (CN) 201010536241.X

(51) Int. Cl. G06F 9/46

(52) U.S. Cl. 718/100

(57) ABSTRACT

A command to perform a task can be received and the task can be started. A command to cancel the task can also be received. The task can be provided with a warning signal and a predetermined grace period of time before cancelling the task, which can allow the task to prepare for cancellation, such as by shutting down cleanly. If the task has not shut down within the grace period, then the task can be cancelled after the grace period expires.

### RELATED CASES

This application claims priority to The People's Republic of China Patent Application No. 201010536241.X, filed Oct. 28, 2010, entitled TASK CANCELLATION GRACE PERIODS.

### BACKGROUND

Large computations or calculations are often executed on clusters of computers. A computer cluster is a group of computing machines that work together or cooperate to perform tasks. A cluster of computers often has a head node and one or more compute nodes. The head node is responsible for allocating compute node resources to jobs, and compute nodes are responsible for performing tasks from the jobs to which their resources are allocated. A job is a request for cluster resources (such as compute node resources) that includes one or more tasks. A task is a piece of computational work that can be performed, such as in one or more compute nodes of a cluster, or in some other environment. A job is started or scheduled by starting one or more tasks in the job.

Sometimes jobs and tasks running on a cluster are cancelled, i.e., terminated before they naturally reach completion. Cancelling a job includes cancelling the tasks in the job that are currently running. A task can be cancelled by terminating processes that are currently performing the computation of the task. Such cancellation may be initiated in various ways and for various reasons, such as in response to user input from an end user or cluster administrator, or as a result of a scheduling policy of the cluster. When a task running on a compute node of the cluster is cancelled, the processes corresponding to the task on the compute node are immediately terminated. Task cancellations may also happen in situations other than in computer clusters, such as in suspend and resume scenarios where tasks may be cancelled, but may resume at a later time.

### SUMMARY

Whatever the advantages of previous task cancellation tools and techniques, they have neither recognized the task cancellation grace period tools and techniques described and claimed herein, nor the advantages produced by such tools and techniques.

In one embodiment, the tools and techniques can include receiving a command to perform a task, and starting the task. Additionally, a command to cancel the task can be received. The task can be sent a warning signal and provided with a predetermined grace period of time before cancelling the task. If the task has not shut down within the grace period, then the task can be cancelled after the grace period expires.

In another embodiment of the tools and techniques, a command to cancel a running task can be received. It can be determined whether to provide the task with a grace period of time before cancelling the task. If the task is not to be provided with the grace period, then the task can be cancelled without waiting for the grace period to expire. If the task is to be provided with the grace period, then the task can be sent a warning signal and provided with the grace period. If the task has not shut down within the grace period, the task can be cancelled after the grace period expires.

In yet another embodiment of the tools and techniques, at a head node of a cluster, it can be determined that a running task is to be cancelled. A command can be sent from the head node to a compute node that is running the task. The command can instruct the compute node to cancel the task. A warning signal can be sent to the task, and if the task has not shut down when a predetermined grace period of time expires, then the task can be cancelled after the grace period expires.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is schematic diagram of an example of a task execution system with cancellation grace periods.

FIG. 3 is a flowchart of a technique for starting a task in the execution system of FIG. 2.

FIG. 4 is a flowchart of a technique for cancelling a task in the execution system of FIG. 2.

FIG. 5 is a flowchart of a task cancellation grace period technique that may be performed in the system of FIG. 2 or some other system.

FIG. 6 is a flowchart of another task cancellation grace period technique that may be performed in the system of FIG. 2 or some other system.

FIG. 7 is a flowchart of yet another task cancellation grace period technique that may be performed in the system of FIG. 2 or some other system.

### DETAILED DESCRIPTION

Embodiments described herein are directed to techniques and tools for improved cancellation of tasks. Such improvements may result from the use of various techniques and tools separately or in combination.

As noted above, when a task running on a compute node of the cluster is cancelled, the processes corresponding to the task on the compute node are typically terminated immediately. Such sudden termination may not allow tasks a chance to save the computational work they had already done before being terminated, resulting in a loss of the already-consumed computational time. The lost computation will be redone the next time the task is run. Moreover, many sophisticated applications will encounter problems in subsequent execution if the applications are not shut down cleanly. For example, unless some applications are correctly shutdown, the applications will run recovery code the next time the applications are invoked, or such applications may leave the compute node in a state that makes it difficult for another user to use the same application on that compute node. The tools and techniques described herein can include providing a grace period for job and task cancellation that informs a task that it is about to be terminated and then allows it a grace period to prepare for cancellation, such as by saving its state and/or shutting down cleanly as it chooses. This may be done in a cluster, and it may also be done in other environments.

Such techniques and tools may include sending a warning signal (e.g., a CTRL_BREAK signal) informing a task that it is about to be cancelled. For example, the task may be a task running in a compute node of a cluster. The task can be allowed a grace period to prepare for cancellation. For example, the task may save its state and/or exit cleanly. If the task is still running after the grace period, the task can be cancelled, such as by forcefully terminating the task's processes. A proxy may be provided to receive a signal warning of cancellation and forward a warning signal to the task's process. For example, where the task is running in a console, the proxy may also be running in the console. The proxy can receive a warning signal, and can forward a warning signal from the proxy to the task within the console. The grace period may be bypassed, such as by an administrator, to speed up cancellation of jobs.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Techniques described herein with reference to flowcharts may be used with one or more of the systems described herein and/or with one or more other systems. For example, the various procedures described herein may be implemented with hardware or software, or a combination of both. Moreover, for the sake of simplicity, flowcharts may not show the various ways in which particular techniques can be used in conjunction with other techniques.

### I. Exemplary Computing Environment

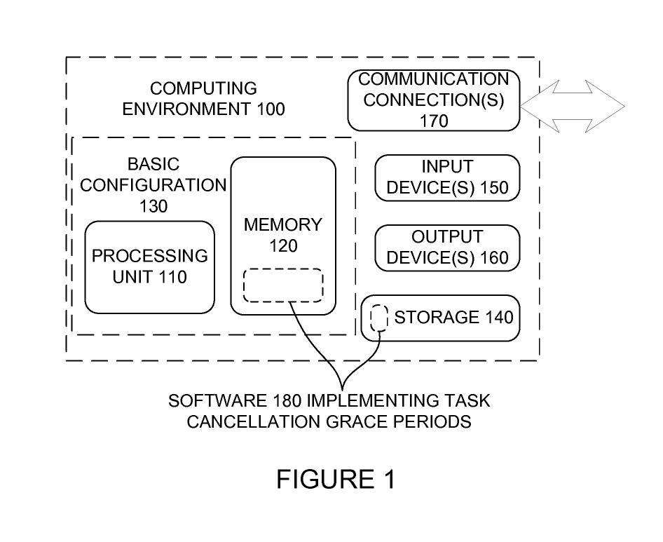

FIG. 1 illustrates a generalized example of a suitable computing environment (100) in which one or more of the described embodiments may be implemented. For example, one or more such computing environments can be used as an environment running a task to be cancelled, such as a compute node. Additionally, such computing environments may be used clients or head nodes. Generally, various different general purpose or special purpose computing system configurations can be used. Examples of well-known computing system configurations that may be suitable for use with the tools and techniques described herein include, but are not limited to, server farms and server clusters, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, the computing environment (100) includes at least one processing unit (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing task cancellation grace periods.

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include non-transitory computer-readable storage media such as magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be a touch input device such as a keyboard, mouse, pen, or trackball; a voice input device; a scanning device; a network adapter; a CD/DVD reader; or another device that provides input to the computing environment (100). The output device(s) (160) may be a display, printer, speaker, CD/DVD-writer, network adapter, or another device that provides output from the computing environment (100).

The communication connection(s) (170) enable communication over a communication medium to another computing entity. Thus, the computing environment (100) may operate in a networked environment using logical connections to one or more remote computing devices, such as a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media. Computer-readable media are any available media that can be accessed within a computing environment. By way of example, and not limitation, with the computing environment (100), computer-readable media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “determine,” “choose,” “adjust,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

II. Task Execution System and Environment with Cancellation Grace Periods

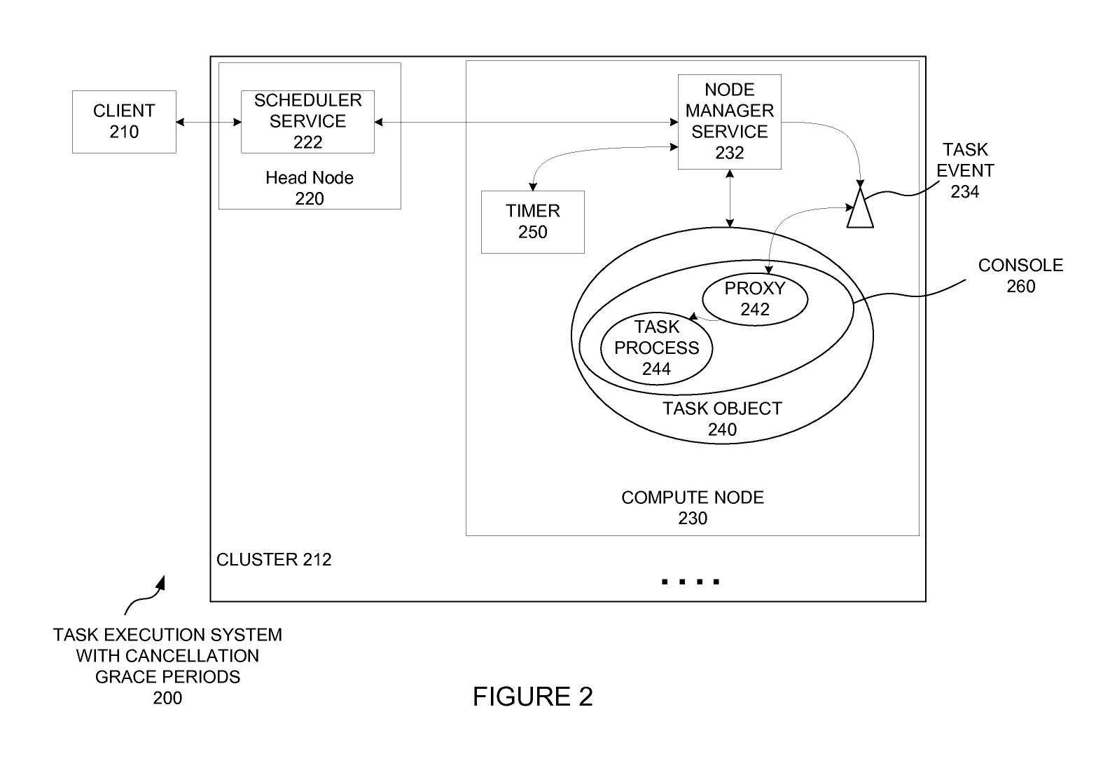

FIG. 2 is a block diagram of a task execution system (200) with cancellation grace periods, in conjunction with which one or more of the described embodiments may be implemented.

The task execution system (200) can be implemented with a client (210) and a cluster (212) that can process jobs for the client (210). The task execution system (200) may also include additional clients and/or additional computer clusters. The client (210) can communicate with the cluster (212), which can include a head node (220) running a scheduler service (222). The scheduler service (222) can communicate with the client (210), such as over standard network connections. The cluster (212) can also include a compute node (230), and it may also include additional compute nodes that work together to perform jobs. Communications between nodes may use standard network messaging formats and techniques. The scheduler service (222) can schedule jobs (such as jobs submitted by clients such as client (210)) and the tasks of those jobs on compute nodes in the cluster (212), such as the compute node (230).

The compute node (230) can run a node manager service (232). For example, the node manager service (232) and the scheduler service (222) may be modules that are components of Microsoft® Windows® HPC Server software. The node manager service (232) can be used by the scheduler service (222) to perform task startup and cancellations on the compute node (230).

As will be discussed more below, the compute node (230) can also run other modules under the direction of the node manager service (232). These other modules may include a task event (234), a task object (240) hosting a proxy (242) and a task process (244). A compute node (230) may also run additional task events, task objects, proxies, and/or task processes.

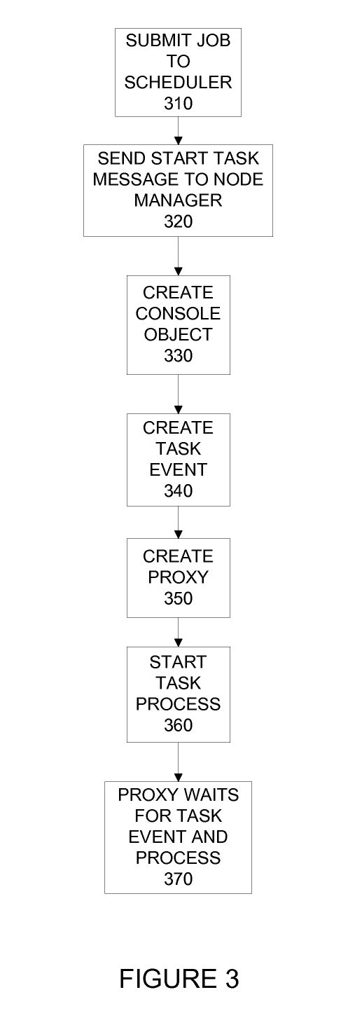

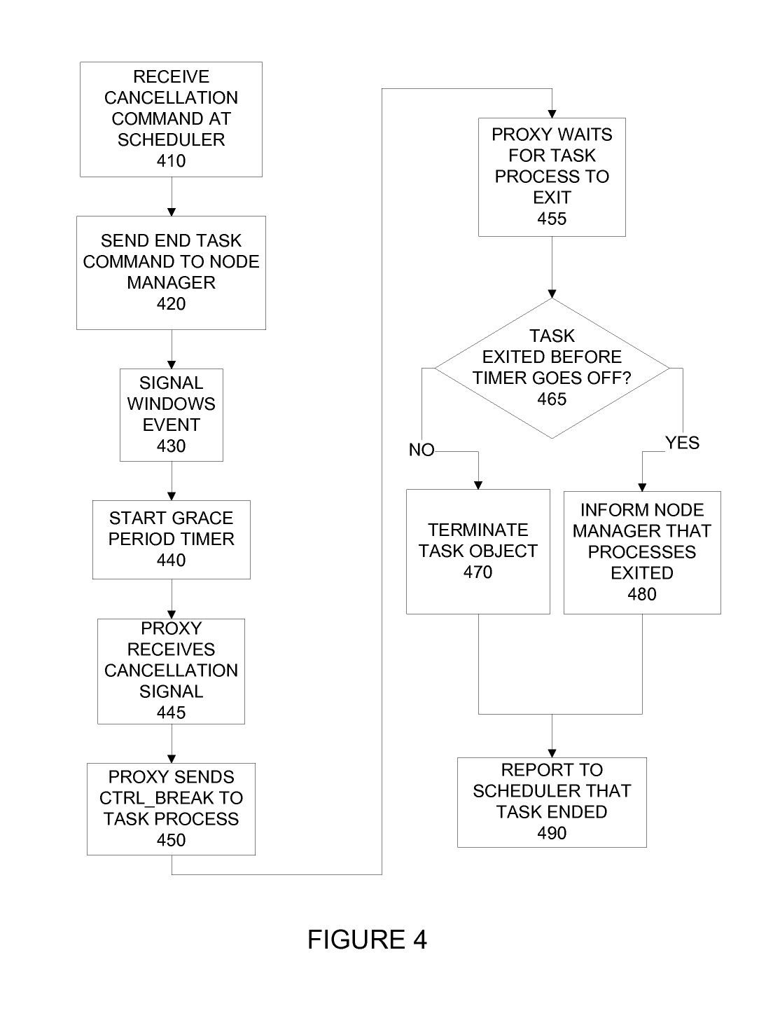

Techniques for starting and cancelling a task within the task execution system (200) will now be described with reference to the flowcharts of FIGS. 3-4, and still with reference to the schematic diagram of FIG. 2.

Referring now to FIGS. 2-3, the techniques can include submitting (310) a job to the scheduler service (222) on the head node (220). To start a task on the compute node (230), the scheduler service (222) can send (320) a start task message to the node manager service (232) on the compute node (230). The start task message can contain information such as a user-provided command line and environment variables that can be used to start processes for that task.

When the node manager service (232) receives the start task message for a task, it can create (330) a task object (240), such as a Windows® job object, for the task. The task object (240) can encapsulate the processes corresponding to that task on the compute node (230). The task object (240) can be started such that any child processes created by the task will not be able to break away from the task object (240). The node manager service (232) can set up the environment for the task's process, such as environment variables, standard out, and standard error. This can also include creating (340) a task event (234), such as a Windows® event, for the task. Instead of creating the process for the task, the node manager service (232) can create (350) a node manager proxy process, or proxy (242), within the task object (240) for the task. The proxy (242) can be passed the identity of the task event (234) created by the node manager service (232), as well as the actual command line for the task. Using this information, the proxy (242) can verify that the identity of the windows event passed to it is valid and can start (360) process(es) (244) for the task in the task object (240) with the command line supplied to it by the node manager service (232). The proxy (242) can then wait (370) for either the task event (234) to be signaled or the task process (244) to exit.

The proxy (242) for a task can be created with a console process creation flag set. Accordingly, each task's processes can be run within the task's own console (260) (which can contain the same processes as are running in the task object (240)), allowing the processes in the console (260) to receive console signals such as CTRL_BREAK from other processes in the console (260), while still maintaining console isolation from other tasks on the compute node (230).

Referring now to FIGS. 2 and 4, the scheduler service (222) can decide to cancel a task because it received (410) a cancellation command. For example, it can receive user input from an end user or an administrator, instructing the scheduler service (222) to cancel the task or its job. The scheduler service (222) may decide to cancel a job or task without receiving such a command. For example, the scheduler service (222) may decide to cancel a task because of a scheduling policy running on the scheduler service (222). When the scheduler service (222) decides to cancel a task, the scheduler service (222) can provide the task with a grace period. For example, this grace period can be set cluster-wide as a default value or in response to user input from an administrator. To provide a specific example, a default value for the grace period may be 15 seconds, but the grace period may be changeable in response to user input from a system administrator. The scheduler service (222) can look up the grace period and send (420) a task cancellation or end task command for that task with the grace period as an argument to the node manager service (232) on the compute node (230) that is running the task.

When the node manager service (232) receives an end task command, it can check whether the grace period supplied by the end task command is more than zero. If the grace period is more than zero, the node manager service (232) can provide that grace period of time to the task's computational processes before cancelling those processes. Specifically, the node manager service (232) can signal (430) the task event (234) created for that particular task and start (440) a timer (250) set to go off at the end of the grace period.

When the proxy (242) corresponding to that task receives (445) the cancellation signal by noticing that the task event (234) has been signaled from the node manager service (232), the proxy (242) can generate a console CTRL_BREAK event and send (450) the event to the user's computational task process (244) it had started earlier. The proxy (242) can then wait (455) for the task process (244) to exit.

After the task process (244) (including all processes for the task in the task object (240)) exits, the proxy (242) itself can exit, and the node manager service (232) can be notified that the processes within the task object (240) have exited. A task process (244) can register a handler for the CTRL_BREAK signal to be able to process that signal.

In response to receiving the CTRL_BREAK signal, which warns the task that the task will be cancelled, the task can respond by preparing for the cancellation. For example, the task may start a clean exit. As another example, a task may initiate a checkpoint and save its state, but not bother to exit. For MPI (message passing interface) tasks, the CTRL_BREAK signal can be passed through smpd to all the processes for that MPI task on all compute nodes. This can be used by the MPI task to do a synchronous checkpoint on all its processes on all its nodes. For service oriented architecture (SOA) applications, receiving the CTRL_BREAK signal could be interpreted as a command to complete the current request and then exit, rather than abandoning the work that has already been performed.

When the grace period ends, the timer (250) can go off (460), and it can be determined (465) whether a task is still running at the end of the grace period. Of course, the timer (250) itself may be terminated before it goes off if the task has already exited. If the task process (244) followed by the proxy (242) exits before the timer (250) on the node manager service (232) goes off at the end of the grace period, the node manager service (232) can be informed (480) that the task process (244) has exited, and can report (490) to the scheduler service (222) that the end task operation has completed. If the timer goes off first, then the node manager service (232) can terminate (470) the task object (240) encapsulating the task's proxy (242) as well as the computational task process (244), and then report (490) to the scheduler service (222) that the end task operation has completed.

A job or task may need to be cancelled immediately without allowing it the grace period. A force option to the cancel command can be provided for a job or a task. For example, this force option may be done in response to user input from a system administrator. For example, when the force option is specified the scheduler service (222) can send out the end task command to the node manager service (232) on the compute node (230), the scheduler service (222) provides a grace period of zero. When the node manager service (232) receives an end task command with a grace period of zero, the node manager service (232) can decide to terminate the task object (240) corresponding to that task immediately, without providing a grace period for the task to prepare for cancellation.

While particular techniques with a particular task execution system (200) have been described, many different variations could be used. For example, the grace period tools and techniques described herein may also be used in environments other than computer clusters. For example, in suspend and resume scenarios that do not involve clusters, a task may be running in an application. The application may be cancelled (suspended), and it may resume at a later time, possibly in another location. When such a task is to be cancelled, the task can be warned and provided with a grace period before cancellation, so the task can prepare for cancellation by saving its state. That saved state can be re-loaded when the task resumes at a later time.

### III. Overall Task Cancellation Grace Period Techniques

Several task cancellation grace period techniques will now be discussed. Each of these techniques can be performed in a computing environment, such as the system of FIG. 2 or some other environment. For example, each technique may be performed in a computer system that includes at least one processor and a memory including instructions stored thereon that when executed by the at least one processor cause the at least one processor to perform the technique (a memory stores instructions (e.g., object code), and when the processor(s) execute(s) those instructions, the processor(s) perform(s) the technique). Similarly, one or more computer-readable storage media may have computer-executable instructions embodied thereon that, when executed by at least one processor, cause the at least one processor to perform the technique.

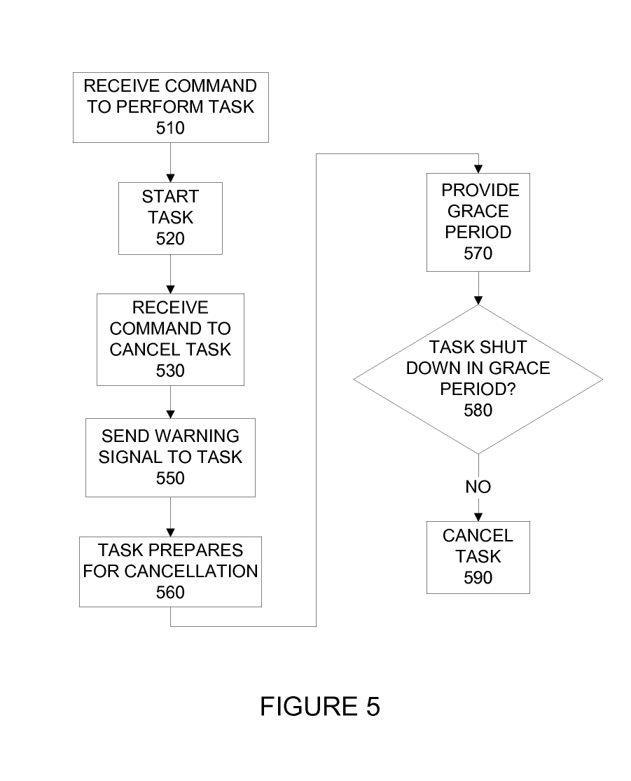

Referring to FIG. 5, a task cancellation grace period technique will be discussed. The technique can include receiving (510) a command to perform a task and starting (520) the task. The technique can also include receiving (530) a command to cancel the task, which can indicate a grace period to give the task before the task is cancelled. In response to receiving (530) the command to cancel the task, a warning signal can be sent (550) to the task. The warning signal can warn the task that the task will be cancelled. The task can respond to the warning signal by preparing (560) for cancellation. For example, the task can prepare (560) for cancellation by saving information from the task (e.g., saving the task's state, such as by saving files and/or other data structures that have been modified by the task) and/or initiating a shut-down procedure for shutting down the task, such as by executing exit procedures for the task. The task can be provided (570) with a predetermined grace period of time (such as an amount of time that is configurable by input from a system administrator) before cancelling the task, and at least a portion of the grace period can remain when the warning signal is sent (550). It can be determined (580) whether task was shut down within the grace period. If not, then the task can be cancelled (590) after the grace period expires.

The technique can be performed in a system that includes a cluster. For example, the technique can be performed by a node of a cluster. The technique may be performed by a compute node, and the command to cancel the task may be received from a head node of the cluster.

The task can be running within a console when the command to cancel the task is received. Additionally, sending (550) the warning signal to the task can include sending a first signal to a proxy running within the console (e.g., by having the proxy listen for signals to an event associated with an object for the console), and sending a second signal from the proxy to the task.

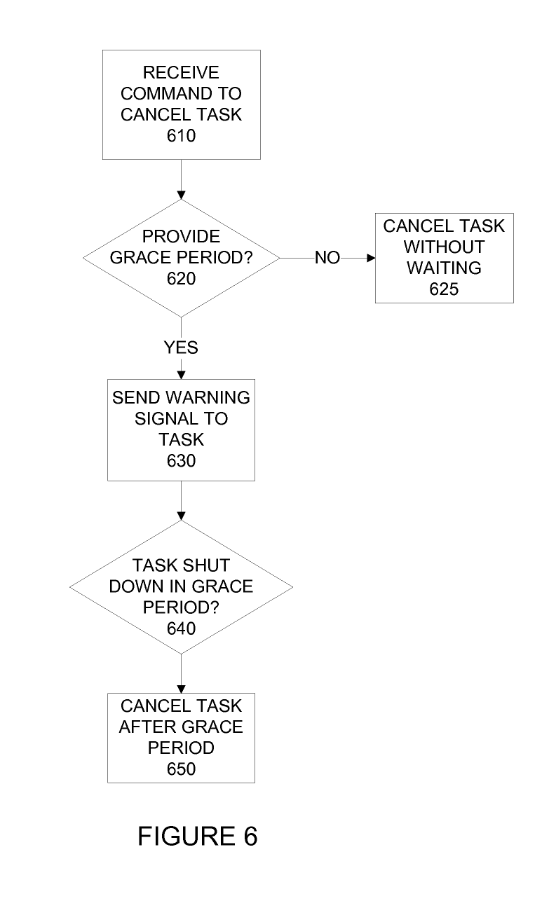

Referring to FIG. 6, another task cancellation grace period technique will be discussed. In this technique, a command to cancel a running task can be received (610). It can be determined (620) whether to provide the task with a grace period of time before cancelling the task. If the task is not to be provided with the grace period, then the task can be cancelled (625) without waiting for the grace period to expire. If the task is to be provided with the grace period, then a warning signal can be sent (630) to the task, warning the task that the task is to be cancelled. The warning signal can be sent (630) while at least a portion of the grace period remains. For example, if the task is running within a console, then sending the warning signal to the task can include sending a signal to the task within the console. Additionally, if the task is to be provided with the grace period, the task can be provided with the grace period and it can be determined (640) whether the task has shut down within the grace period. If not, then the task can be cancelled (650) after the grace period expires.

Determining (620) whether to provide the task with the grace period can include examining the command to cancel the task to determine whether the command indicates a grace period greater than zero, and/or determining whether a grace period field (e.g., a grace period field in the command to cancel the task) is set to a zero value.

The technique of FIG. 6 may be performed by a compute node of a cluster where the task is running before the command to cancel the task is received.

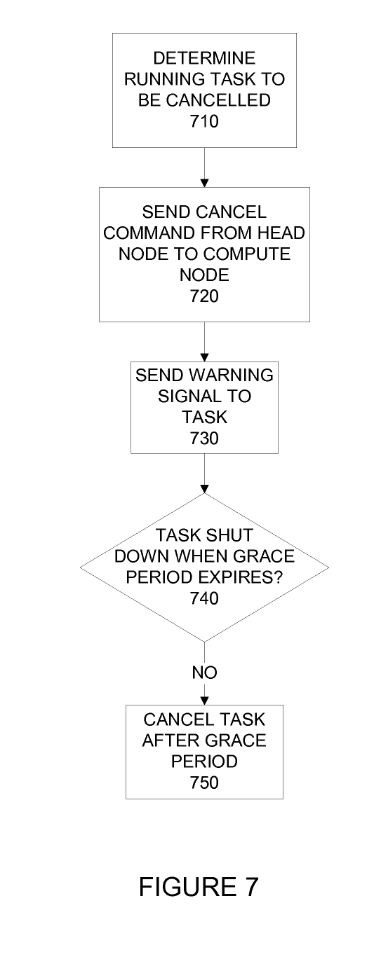

Referring to FIG. 7, yet another task cancellation grace period technique will be discussed. In the technique, at a head node of a cluster, it can be determined (710) that a running task is to be cancelled. For example, this may be done in response to a message from a client, in response to user input at the head node, in response to a scheduling process on the head node, etc. A command can be sent (720) from the head node to a compute node that is running the task. The command can instruct the compute node to cancel the task. A warning signal can be sent (730) to the task. For example, the warning signal may include a CTRL_BREAK signal. Additionally, it can be determined (740) whether the task has shut down when a predetermined grace period of time expires. If not, then the task can be cancelled (750) after the grace period expires.

The compute node may be a first compute node, which can be a compute node that coordinates between different portions of a task running in multiple compute nodes. Accordingly, the task may also be running in one or more other compute nodes that are receiving instructions from a portion of the task running in the first compute node. In this situation, cancelling the task can include cancelling the portion of the task running in the first compute node and the portion(s) running in the other compute node(s).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A computer-implemented method, comprising:
receiving a command to perform a task;
starting the task;
receiving a command to cancel the task;
sending a warning signal to the task, the warning signal warning the task that the task is to be cancelled;
providing the task with a predetermined grace period of time before cancelling the task; and
if the task has not shut down within the grace period, then cancelling the task after the grace period expires.

2. The method of claim 1, wherein the command to cancel the task indicates the grace period.

3. The method of claim 1, wherein the warning signal is sent to the task while at least a portion of the grace period remains.

4. The method of claim 3, wherein the task responds to the warning signal by preparing for cancellation.

5. The method of claim 4, wherein preparing for cancellation comprises saving information from the task.

6. The method of claim 4, wherein preparing for cancellation comprises initiating a shut-down procedure for shutting down the task.

7. The method of claim 1, wherein the method is performed by a node of a cluster.

8. The method of claim 7, wherein the node of the cluster is a compute node, and wherein the command to cancel the task is received from a head node of the cluster.

9. The method of claim 1, wherein the task is running within a console when the command to cancel the task is received.

10. The method of claim 9, further comprising, in response to receiving the command to cancel the task, sending a warning signal to the task, the warning signal warning the task that the task will be cancelled, wherein sending the warning signal to the task comprises sending a first signal to a proxy running within the console, and sending a second signal from the proxy to the task.

11. The method of claim 1, wherein:
the method further comprises:
in response to receiving the command to cancel the task, sending a warning signal to the task, the warning signal warning the task that the task will be cancelled;
the command to cancel the task indicates the grace period;
the method is performed by a compute node of a cluster;
the command to cancel the task is received from a head node of the cluster; and
sending the warning signal to the task comprises sending a first signal to a proxy running within a console where the task is running, and sending a second signal from the proxy to the task.

12. A computer system comprising:
at least one processor; and
a memory comprising instructions stored thereon that when executed by the at least one processor cause the at least one processor to perform acts comprising:
receiving a command to cancel a running task;
determining whether to provide the task with a grace period of time before cancelling the task;
if the task is not to be provided with the grace period, then cancelling the task without waiting for the grace period to expire; and
if the task is to be provided with the grace period, then sending a warning signal to the task and providing the task with the grace period, and if the task has not shut down within the grace period, then cancelling the task after the grace period expires.

13. The computer system of claim 12, wherein determining whether to provide the task with the grace period comprises determining whether a grace period field is set to a zero value.

14. The computer system of claim 12, wherein determining whether to provide the task with the grace period comprises examining the command to cancel the task to determine whether the command indicates a grace period greater than zero.

15. The computer system of claim 12, wherein the computer system comprises a cluster, and wherein the at least one processor and the memory are part of a compute node of the cluster where the task is running before the command to cancel the task is received.

16. The computer system of claim 12, sending the warning signal comprises sending the warning signal while at least a portion of the grace period remains.

17. The computer system of claim 16, wherein the task is running within a console, and wherein sending the warning signal to the task comprises sending a signal to the task within the console.

18. One or more computer-readable storage media having computer-executable instructions embodied thereon that, when executed by at least one processor, cause the at least one processor to perform acts comprising:
at a head node of a cluster, determining that a running task is to be cancelled;
sending a command from the head node to a compute node that is running the task, the command instructing the compute node to cancel the task;
sending a warning signal to the task; and
if the task has not shut down when a predetermined grace period of time expires, then cancelling the task after the grace period expires.

19. The one or more computer-readable storage media of claim 18, wherein the warning signal comprises a CTRL_BREAK signal.

20. The one or more computer-readable storage media of claim 18, wherein the compute node is a first compute node, and the task also runs in one or more other compute nodes that are receiving instructions from a portion of the task running in the first compute node.
